(19) United States
(12) Patent Application Publication
(10) Pub. No.: US 2024/0168981 A1
(43) Pub. Date: May 23, 2024

(54) PREDICTIVE CASE STRATEGY SYSTEMS AND METHODS FOR DETERMINATION OF CUSTODIANS

(71) Applicant: Open Text Holdings, Inc., Halifax (CA)

(72) Inventors: Bruce Edward Kiefer, Denver, CO (US); Rakesh Babulal Bhatt, Castle Pines, CO (US); Jeremy Garner Pickens, Bloomville, NY (US); Sreedevi Balaji, Secunderabad (IN)

(21) Appl. No.: 18/517,322

(22) Filed: Nov. 22, 2023

Related U.S. Application Data
(60) Provisional application No. 63/384,648, filed on Nov. 22, 2022.

(51) Int. Cl. G06F 16/332; G06F 16/338

(52) U.S. Cl. CPC G06F 16/3323; G06F 16/338

(57) ABSTRACT

Systems, methods and products for reducing discovery costs by automating the discovery of custodians of materials that are relevant to a particular litigation matter. The disclosed embodiments examine the data that is available through various data management tools and corresponding data stores, assign weights to various pieces of information that are available based on the types of the data, their associations with particular custodians or matters, etc., and rank a set of potential custodians based on the data and associated weights that are associated with the respective potential custodians. The disclosed embodiments then select, based on their respective rankings, a group including a configurable number of the potential custodians. The selected group of potential custodians can then be provided to an output interface.

### RELATED APPLICATION(S)

The present application claims the benefit of priority under 35 U.S.C. § 119(e) of U.S. Provisional Patent Application No. 63/384,648 filed Nov. 22, 2022, entitled “PREDICTIVE CASE STRATEGY SYSTEMS AND METHODS FOR DETERMINATION OF CUSTODIANS,” which is hereby fully incorporated by reference herein.

### TECHNICAL FIELD

This disclosure relates generally to data management, and more particularly to systems and methods for data management wherein more relevant data custodians can be identified to enable greater accuracy in cost estimation and data storage associated with the handling of electronic discovery data.

### BACKGROUND

It is well known that litigation can be a very complex, lengthy and expensive process. Before embarking on this process, it is desirable to attempt to estimate just how long and costly the process will be. Historically, it has been very difficult to estimate the time or cost of the various phases (e.g., discovery) of litigation, and the process for making these estimations is typically not very accurate.

For example, referring to FIG. 1, electronic discovery (sometimes referred to as eDiscovery) costs are frequently determined using a relatively simple spreadsheet that uses simple multipliers to calculate the costs of particular components of the discovery process. The spreadsheet may have fields in which known quantities such as the number of data custodians, amount of data collected, amount of data hosted, total documents/data volume to review and rate at which the data is responsive to discovery requests. These values are then multiplied by factors corresponding to collection, processing, hosting, review and production of the discovery data.

This method of calculating costs is very unsophisticated and may be inaccurate, not only because of the simplistic use of the cost factors, but also because some of the values input to the spreadsheet may be guesses or estimates that are based more on hunches than actual data. For example, the spreadsheet in the example of FIG. 1 shows that there are 10 custodians, but this number may include persons that are not closely related to the matter at issue, or that are duplicative (e.g., a single person may have multiple email addresses or identifiers that are mistakenly interpreted as different custodians).

It would therefore be desirable to have systems for estimating cost which use techniques that provide more accurate results for the estimation of eDiscovery costs.

### SUMMARY

The present disclosure details systems, methods and products for reducing discovery costs by automating the discovery of custodians of materials that are relevant to a particular litigation matter. The disclosed embodiments examine the data that is available through various data management tools and corresponding data stores, assigns weights to various pieces of information that are available based on the types of the data, their associations with particular custodians or matters, etc., and ranks a set of potential custodians based on the data and associated weights that are associated with the respective potential custodians. The disclosed embodiments then select a group of the potential custodians based on their respective rankings. The set may include a configurable number of the potential custodians (e.g., for a less complex matter, a smaller number of the potential custodians may be selected, or for a more complex matter, a greater number of the potential custodians may be selected).

One embodiment comprises an automated system for electronic discovery of documents and document custodians, the system including an electronic discovery server machine that is coupled by a network to receive data from a plurality of data sources, each of the data sources storing data of a corresponding data management tool. The electronic discovery server machine is adapted to an identifier of a first custodian receive from an input interface and to obtain data items associated with the first custodian from the data sources. The electronic discovery server machine is further adapted to identify one or more matters associated with the first custodian based on the obtained data items. The electronic discovery server machine also determines from the obtained data items identifiers of potential custodians associated with the identified matters. The electronic discovery server machine compares, for each of the potential custodians, data items associated with the potential custodian to determine a corresponding level of relevance of the potential custodian to a target matter. The electronic discovery server machine then selects a subset of the potential custodians having corresponding levels of relevance above a configurable threshold, generates output including the selected subset of the potential custodians, and provides this output to an output interface.

Numerous alternative embodiments may also be possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagram illustrating a cost calculation spreadsheet in accordance with the prior art.

FIG. 2 is a flow diagram illustrating phases of eDiscovery in accordance with some embodiments.

FIG. 3 is a flow diagram illustrating an exemplary method for identifying relevant custodians of information in accordance with some embodiments.

FIG. 4 is a flow diagram illustrating the collection of data and building of a custodian profile in accordance with some embodiments.

FIGS. 5A-5E are a flow diagram illustrating the collection of data and building of a matter profile in accordance with some embodiments.

FIG. 6 is a flow diagram illustrating the comparison of entities to determine whether they are different instances of the same custodian and to determine the relevance of the custodians for presentation to users in accordance with some embodiments.

FIG. 7 is a block diagram illustrating an exemplary predictive case strategy system in accordance with some embodiments.

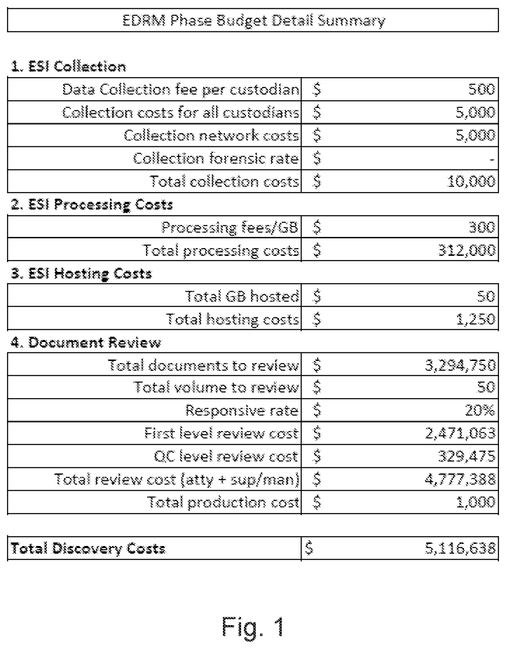

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

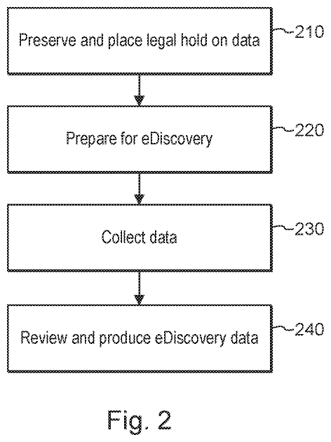

eDiscovery may be characterized by several different phases: preparation for preservation of data and legal hold; preparation for eDiscovery (including identification of custodians); preparation for search and collection of data; and preparation for review and production of data. These phases are illustrated in FIG. 2, and are described in more detail below. Each of the many steps involved in the eDiscovery process (e.g., Identifying documents collecting data reviewing collected information, etc.) affects the cost of discovery, but none of these actions are addressed in any significant way in conventional discovery cost estimations. Where these conventional estimations are very simplistic in the use of multipliers for broad categories of costs (e.g., collection, processing, hosting, review, production) and have not been tested or vetted in any meaningful way, embodiments disclosed herein make use of available detailed data to more accurately predict the time, effort and costs associated with eDiscovery.

Referring to FIG. 2, a flow diagram illustrating the different phases of eDiscovery in some embodiments is shown. The first step (210) in the eDiscovery process is preservation of data and placing a legal hold on appropriate data for a particular matter. Initially, an in-house Legal department will review and identify potential custodians, data types and data sources, and will Enter the basic information for the matter in a matter management system. A legal hold notification system may be used to maintain information for the matter, to provide legal hold notifications and questionnaires to potential custodians of data relevant to the matter, and to maintain records of custodian acknowledgment (or lack thereof) of the legal hold notifications.

The second step (220) in the eDiscovery process is to prepare for eDiscovery. This involves conducting interviews with custodians to review custodian questionnaires, confirm data sources and collect physical files. Information collected during custodian interviews may be recorded (e.g., in a legal hold tool) and the chain of custody for collected files may be recorded. Some of the data collected for purposes of discovery may be stored in a collection repository, while other data may be preserved in place. Physical files may be electronically scanned, and the electronic scans may be saved in the collection repository while the physical files are returned to the custodians.

The third step (230) in the eDiscovery process is the search and collection of data. In this phase, legal teams review legal hold status reports and chain of custody logs and create criteria for searching the data. Questionnaires of previously identified custodians may be reviewed to identify potentially responsive data, and legal hold notifications may be provided to newly identified custodians. Search queries may be formulated and executed, and search results may be provided to legal teams for review and acceptance or revision. Search results (including data) may be exported and provided to the legal teams or litigation support vendors. The data may also be loaded into a document review tool for further processing.

The fourth step (240) in the eDiscovery process is the review and production of eDiscovery data. Legal teams may create protocols for reviewing the data, examine review tools to ensure that they are compliant with accepted review protocols, and review the data. Based on the review, data may be identified for production and this data may be exported and provided to opposing counsel. Privilege logs and production logs may be generated and the chain of custody for produced data may be updated as needed.

It should be noted that the involvement of the custodians in this process can significantly impact the scope (and therefore the cost) eDiscovery. In other words, the more custodians, the greater the cost. Consequently, the identification of which custodians are most relevant and which are most significant with respect to a particular matter can be an important factor in the estimation of eDiscovery costs.

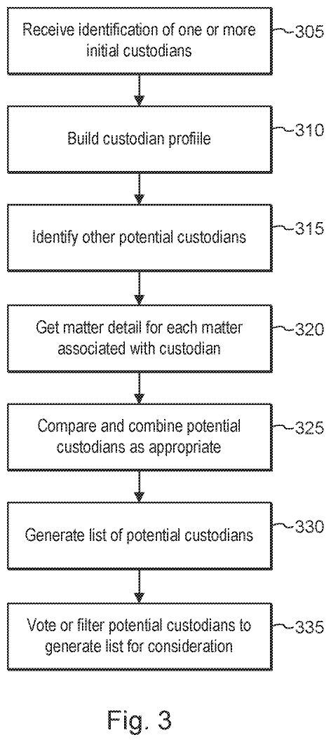

Referring to FIG. 3, a flow diagram is shown to illustrate an exemplary method for identifying relevant custodians of information in accordance with some embodiments. As noted above, the accurate identification of relevant custodians results in more accurate estimation of eDiscovery costs, and consequently better information upon which litigation decisions can be made. Additionally, the techniques disclosed herein can consolidate custodians which are actually duplicative instances of a single custodian, which can reduce the amount of data that needs to be stored. Further, by identifying the most relevant custodians, it may be possible to eliminate the need to store data associated with less relevant custodians, thereby reducing the associated storage costs.

In the exemplary method of FIG. 3, one or more initially identified custodians are provided to a predictive case strategy system (305). For each custodian, a profile is constructed (310) using data that is available for the organization. The profile may include information such as the custodian's current role within the organization, their supervisor, department, etc.

In addition to collecting information about the custodian, the predictive case strategy system identifies other persons that are associated with the custodian, such as team members who have worked with the custodian (315). These other persons may have additional information that is relevant to the matter being investigated, and may potentially be identified as custodians themselves. The predictive case strategy system also identifies any matters with which the initial custodian has been associated and collects detailed information related to these matters (320).

In the process of identifying potential custodians, the predictive case strategy system may have identified a number of different entities or personas which may actually be representative of a single custodian. The system therefore examines the different entities, tries to determine whether any of these entities are actually the same person, and consolidates the information for different entities that represent a single custodian (325). After consolidating entities that correspond to a single custodian, the system may generate a list of potential custodians (330). There may be a very large number of persons who are identified as potential custodians, but it is typically the case that Only a subset of these potential custodians actually has a significant amount of information which is relevant to the matter at issue. The predictive case strategy system may therefore examine various factors that may affect the perceived relevance of each potential custodian and may enable “voting” for each of the potential custodians, or filtering of the potential custodians to eliminate less significant ones and reduce the number of potential custodians that are actually presented to a user for further consideration (335).

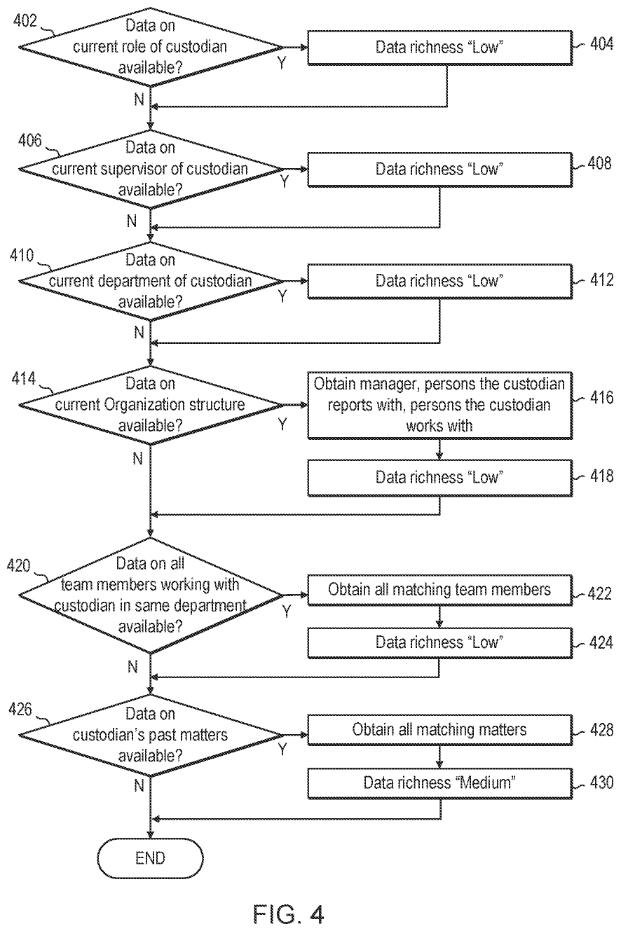

Referring to FIG. 4, a diagram is shown to illustrate in more detail the collection of data and building of the custodian profile in accordance with some embodiments. This process is initially performed for a first custodian that is identified by a user as an input. the process may be repeated for one or more additional custodians that are input by the user, and may also be repeated for one or more custodians that are identified during the process of FIG. 3.

As depicted in this figure, the predictive case strategy system first attempts to obtain a current role for the custodian (402). Data may or may not be available regarding the custodian's role. If data is available, the custodian's profile may be updated to indicate that The profile has a “low” richness (404). If no data is available, no indication of data richness will be made or updated based on this information.

For the purposes of this disclosure, the “data richness” of the custodian profile is an indicator of how much information is available regarding the custodian, which itself may be used as an indicator of the relevance and or accuracy of the custodian's profile. This may be taken into account, for example, when making comparisons of custodian profiles to determine whether they represent different instances of the same custodian, or when determining the relevance or significance of a custodian with respect to a particular matter. In this particular example, the data richness of the custodian profile is stratified according to several discrete levels, so the data richness of the profile may be characterized by “low”, “medium” or “high” levels of data richness (or no data richness at all).

It should also be noted that references herein to setting levels of data richness or relevance of custodian profiles or the like to “low”, “medium” or “high” levels are presented as representative of various possible methods for voting on the significance or relevance of the profiles. Where the disclosure indicates that the methods set or upgrade the levels (e.g., from no indication to “low”, from “low” to “medium” or from “medium” to “high”), this should be generally construed as an upgrade or upvote of the indicator. conversely, if the indicator is already at a higher level, the indicator may be downgraded or downloaded (e.g., from “high” to “medium”, from “medium” to “low”, etc.) in response to determining that data is not available, that there is no direct communication evidence, etc. The upvoting and downvoting, the specific levels of the indicators, and other details of the voting or relevance indicator mechanism may vary from one embodiment to another.

After the system attempts to obtain information on the custodian's current role, it attempts to obtain information on the custodian's current supervisor and current department (406). As in the case of the current role, if data is available, the system updates the profile to indicate “low” data richness (408), but if no data is available, no update is made to the indication of the richness of the profile.

The predictive case strategy system then attempts to obtain the current structure of the organization to which the custodian belongs (410). This information may include persons with whom the custodian works, persons to whom the custodian reports, persons who report to the custodian, etc. Again, if relevant data is available, the data richness of the custodian profile is updated to reflect “low” data richness (412), or is not updated if no data is available. The system then determines whether information is available on the custodian's organization structure (414). If this information is available, the system attempts to identify all team members working with the custodian (416). If team members (e.g., “TM1”, “TM2”, etc.) can be identified, the data richness of the profile is updated to “low” (418). If no team members can be identified, the profile richness is not updated.

The system also attempts to determine whether there is information available on team members who are working within the same department as the initially identified custodian (420). If so, the system identifies all matching team members (422) and updates the data richness of the profile to “low” (424).

The system then attempts to identify all matters with which the custodian has been associated (e.g., “M1”, “M2”, etc.) (426). If this data is available, the information on matching matters is obtained (428), and the data richness of the profile is updated to “medium” (430). If no data is available, the data richness is not updated.

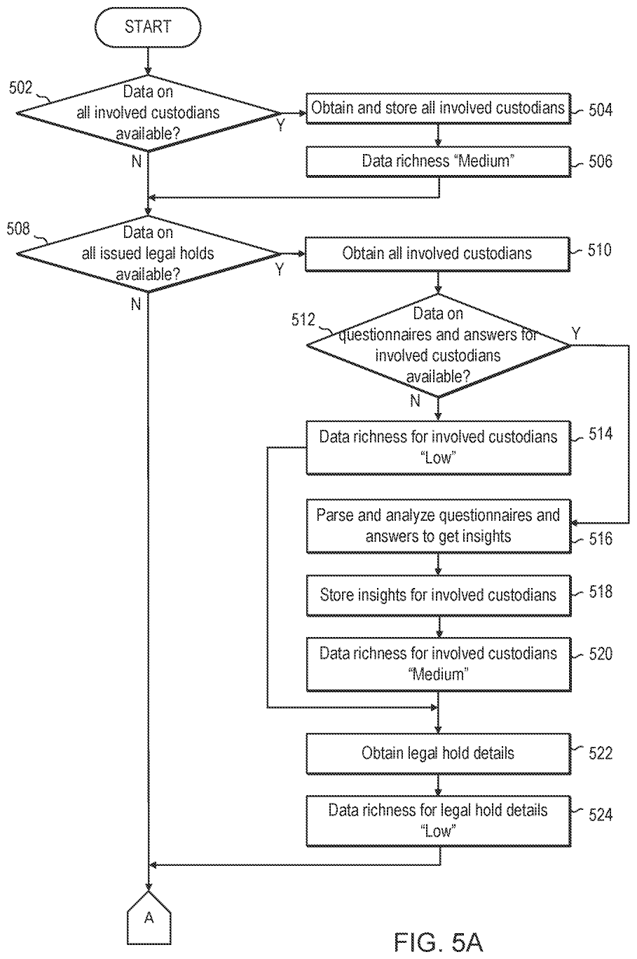

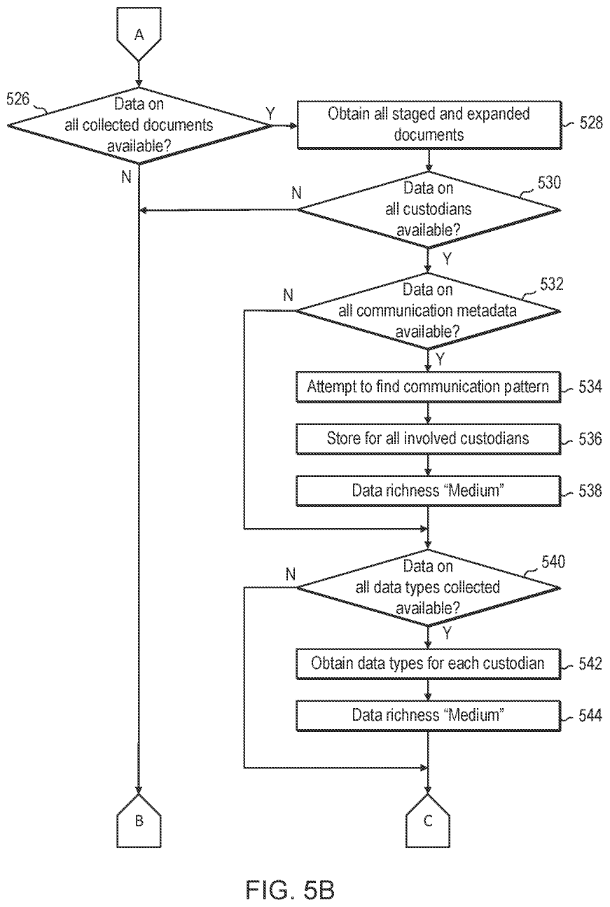

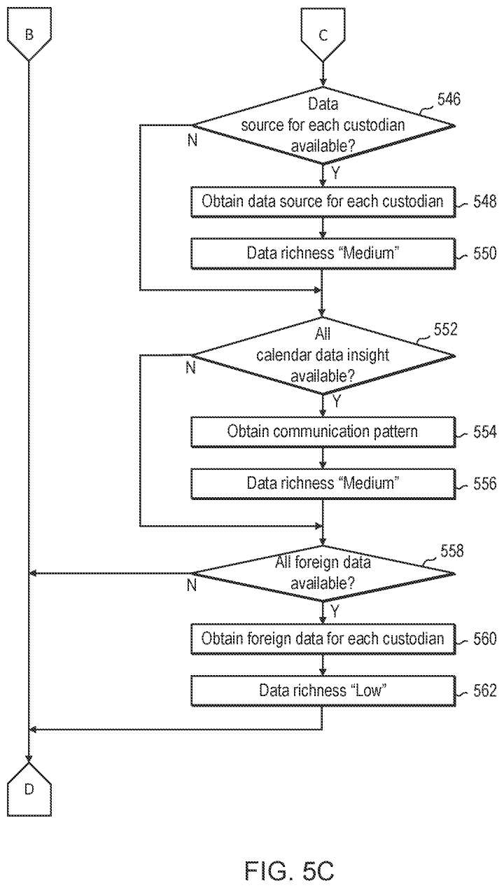

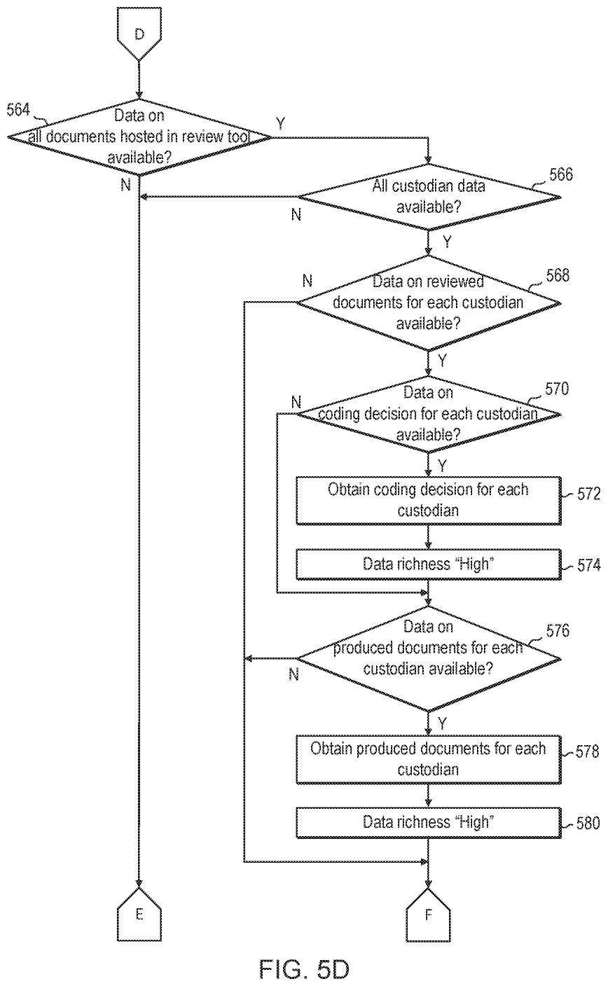

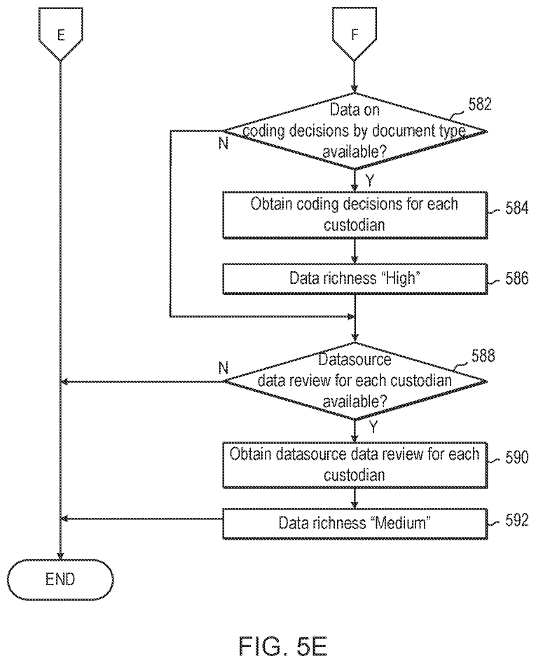

Referring to FIGS. 5A-5E, a flow diagram is shown to illustrate in more detail the collection of data and building of the matter profile in accordance with some embodiments. Each figure comprises a subpart of the overall flow diagram. In the process illustrated by FIGS. 5A-5E, information associated with each of the matters identified with the custodian is examined and a corresponding matter profile is generated. like the custodian profile, the matter profile as an associated data richness which may be characterized by “low”, “medium” or “high” levels of richness. In this example, the matters are examined sequentially, with information being collected on a first matter, then a second matter, and so on until each of the matters associated with the custodian have been examined.

Referring to FIG. 5A, the first step in the process of collecting data and building a matter profile is to identify all of the custodians that are involved with the matter (502). If this information is available, the identified custodians are stored (504), and the data richness of the matter profile is updated to “medium” (506). The system then identifies all legal holds that have been issued for the matter and identifies all of the involved custodians (508). The details of the legal holds are obtained (510), and any custodian questionnaires and answers are also obtained (512). If no data on the custodian questionnaires and answers is available, the data richness of the matter profile remains “low” (514), but if data is available, and the system is able to parse this information and obtain insights from it (516), insights for the involved custodians are stored (518), and the richness of the matter profile is updated to “medium” (520). Details of the legal holds are then obtained (522), and the data richness of the matter profile remains “low” (524).

The predictive case strategy system then determines whether there is data available on all collected documents (526). If so, the system obtains all staged and expanded documents that are available with respect to the matter (528). If no collected documents are available, the data richness of the profile is not updated. The system then determines whether there is data available on all custodians (530). If there is no custodian data available, the matter profile richness is not updated. If this data is available, the system then determines whether there is metadata available for all communications (532). If so, the system attempts to find patterns in the communications (534). Identified patterns are stored for all custodians (536), and the richness of the profile is updated to “medium” (538).

Whether or not there is communication metadata available, the system then determines whether there is data available on the collected data types (540). If this data is available, the system obtains the data types for each custodian (542) and the data richness of the profile is updated to “medium” (544).

Referring to FIG. 5C, the system then determines whether the data sources for each custodian are available (546). If this data is available, the data source for each custodian is obtained (548) and the richness of the profile is updated to “medium” (550). Whether or not the data sources for the custodians are available (546), the system then determines whether calendar data insight is available (552). If this data is available, the system attempts to find communication patterns based on the data (554) and updates the richness of the profile to “medium” (556).

Whether or not the calendar data insight is available (552), the system proceeds to determine whether all foreign data that has been collected with respect to the matter is available (558). If this data is available, the system obtains foreign data for each custodian (560) and updates the richness of the profile to “low” (562). If none of this data is available, the profile's data richness is not updated. After the foreign data for each custodian is obtained, or if there is no foreign data for the custodians, the method proceeds to step 564 (see FIG. 5D).

The predictive case strategy system then attempts to determine whether data is available on all documents hosted in an associated review tool (564). If no such information is available, the data richness of the profile is not updated. If data is available, the system determines whether all custodian data is available (566). If none of this data is available, the profile's data richness is not updated.

The system then determines whether data is available on reviewed documents for each custodian (568). If no such information is available, the data richness of the profile is not updated, and the method proceeds to step 582. If this information is available, the system determines whether data is available on coding decisions for each custodian (570). If information is available on the coding decisions for each custodian, the system obtains coding decisions for each of the custodians (572), and the profile's data richness is updated to “high” (574).

Whether or not data is available on reviewed documents for each custodian, the system determines whether there is data available on the documents produced for each custodian (576). If no such information is available, the data richness of the profile is not updated, and the method proceeds to step 582. If this data is available, the produced documents for each custodian are obtained (578), and the data richness of the profile is updated to “high” (580).

The system then determines whether data is available on coding decisions by document type (582). If this information is available, the system obtains the coding decisions by document type (584), and the data richness of the profile is updated to “high” (586). Whether or not data is available on coding decisions by document type, the system determines whether data is available on data sources for data reviewed by each custodian (588). If no such information is available, the data richness of the profile is not updated, and the method ends. If this information is available, the system obtains the data sources for data reviewed by each custodian (590) and the data richness of the profile is updated to “high” (592).

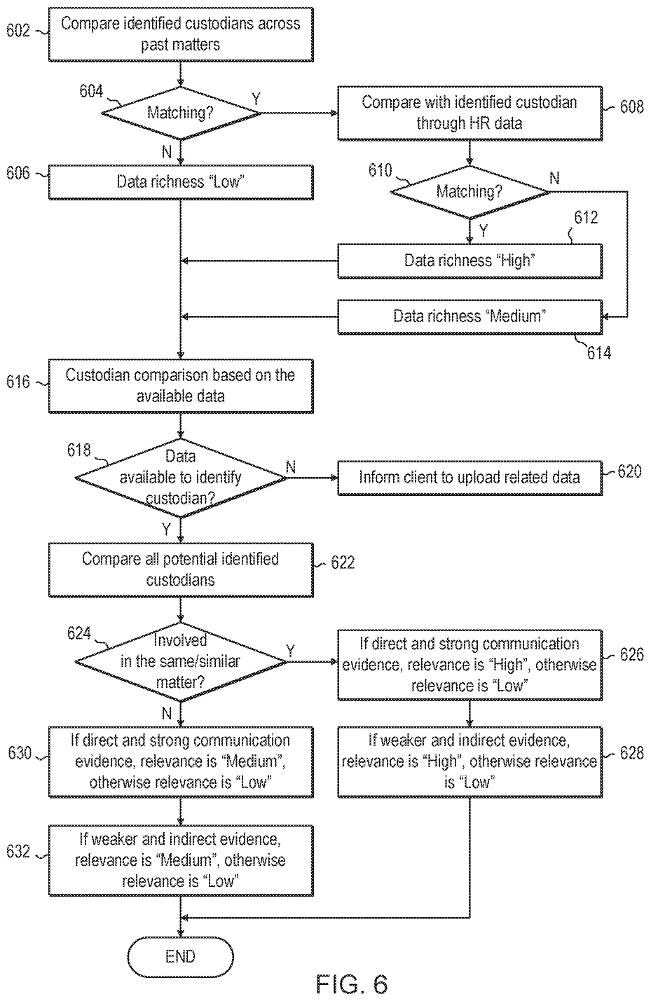

Referring to FIG. 6, a flow diagram is shown to illustrate in more detail the comparison of entities to determine whether they are different instances of the same custodian and to determine the relevance of the custodians for presentation to users in accordance with some embodiments. In this method, potential custodians that have been identified through the preceding processes (see FIGS. 4 and 5A-5E) are examined to determine whether some of the identified potential custodians are actually different instances of the same person, and they are examined to determine which of the potential custodians are sufficiently relevant to the matter at issue to be identified to a user.

In the method of FIG. 6, the custodians are first compared across past matters (602). As noted above, during the process of reviewing people who are associated with a matter, persons may be identified in various different ways. For example, they may be identified by email addresses, names in the subjects or bodies of emails, names in organization charts (org charts), etc. In one example, a search of data associated with initial custodian may find the personas jsmith@acme.com (from an email address), Jonathan Smith (from an org chart), and Jon Smith (mentioned in the body of a letter).

If it is determined that multiple personas compared across past matters represent the same person (604), the data for all of these personas is combined and is associated with a single custodian representing the person corresponding to the matching personas. The data for the custodians may also be compared with data sources such as human resources (HR) data (608) and, if a match is found (610), the custodian's information may be augmented with data from this data source. In the case that the custodians match using the HR information, the data richness of the custodian's profile is updated to “high” (612). If no match is found with the HR data, the data richness of the profile is “medium” (614). In the comparison of the potential custodians across past matters (602), it may be determined that there are no matches for a given custodian, in which case the data richness of that custodian's profile will be “low” (606).

After the identified potential custodians have been compared across past matters to combine any of them, the remaining potential custodians are compared to the available data that has been collected by the system (616). If there is no data available that is associated with a particular custodian (618), the user is notified that data for the potential custodian needs to be uploaded (620). If there is data available that is associated with a particular custodian, all identified potential custodians are compared (622), and it is determined whether this data indicates that the potential custodian was involved in a matter which is the same or similar to the one at issue (624).

If the potential custodian was involved in the same matter or one that is similar, it is determined whether there is direct and strong communication evidence of the potential custodian's involvement in the matter of interest (626). If so, the relevance of the custodian is determined to be “high”. If there is no such direct and strong communication evidence, the relevance of the potential custodian is determined to be “low”. It is also determined if there is weaker and indirect evidence that the potential custodian is involved in the same or similar matter (628). If so, the relevance of the potential custodian is determined to be “high”, but if not, the relevance of the potential custodian is determined to be “low”.

If the potential custodian was not involved in a matter that is the same or similar to the one at issue, it is also determined whether there is direct and strong communication evidence of the potential custodian's involvement in the matter of interest (630), but if so, the relevance of the custodian is determined to be “medium” instead of “high”. If there is no direct and strong communication evidence of involvement in the matter of interest, the relevance of the potential custodian is determined to be “low”. Similarly, it is determined if there is weaker and indirect evidence that the potential custodian is involved in the same or similar matter (632) and, if so, the relevance of the potential custodian is determined to be “medium”. If there is no weaker and indirect evidence of the potential custodian's involvement, the relevance of the potential custodian is determined to be “low”.

After the relevance of each of the various potential custodians has been determined, the system may rank the custodians based on the associated relevance indications and may select a subset of the custodians based on the corresponding rankings. For example, if the system identifies 50 potential custodians, this number may be considered too large for all of the potential custodians to be considered significant, so the system may present the user with only A predetermined number or percentage of the potential custodians that have the highest relevance indications, or only ones of the custodians having relevance indications that exceed a predetermined threshold. The selected subset of potential custodians is then presented to a user you or provided to another component of the predictive case strategy system for further consideration, inclusion in case notes, etc.

In addition to determining the relevance of the various potential custodians, the predictive case strategy system may be configured to filter the potential custodians (and possibly the collected data) to remove data that is not relevant to the matter at issue. For instance, the processes described above may initially be carried out without regard to whether or not the information is “current” with respect to the matter at issue. It may therefore be necessary to remove information that is not current (or is not relevant to the matter at issue) from consideration.

For example, if a person is identified as a potential custodian because they are employed by an organization, but they did not begin their employment with the organization until after an event in dispute occurred, or if they left the organization before the event, their connection to the matter at issue may not be considered current, so they may be disregarded as a potential custodian. Similarly, if a person is considered to be a potential custodian because they were included in email communications with an initially identified custodian, they may not be relevant to the matter at issue if the communications were made outside a window of time relevant to the matter. Numerous other similar considerations may be used to filter the potential custodians or other collected information, thereby reducing the amount of information that must be considered in assessing the matter. Reducing the amount of information to be considered in turn reduces the anticipated cost of eDiscovery related to the matter.

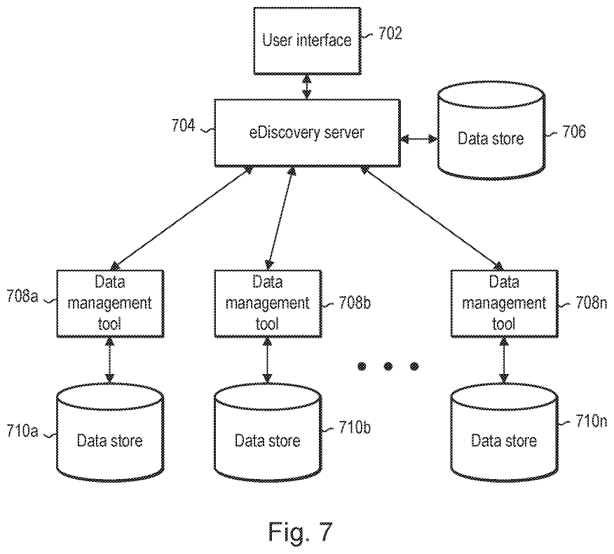

The predictive case strategy system may be implemented in a variety of different topologies. Referring to FIG. 7, in one embodiment, the system includes a plurality of data sources 710 coupled by a network to an electronic discovery server 704. Each of the data sources stores data of a corresponding data management tool 708, the plurality of data sources storing multiple, disparate types of data for the corresponding data management tools in multiple, disparate data structures. In this embodiment, the eDiscovery server is adapted to receive an identifier of a first custodian from an input interface 702 and access the data management tools to obtain data items associated with the first custodian. The obtained data items are stored in a data store 706 in an original format as they are obtained from the corresponding data management tools. The eDiscovery server builds a custodian profile for the first custodian with the obtained data items and determines matters associated with the first custodian from the obtained data items. For each of the identified matters, the system builds a corresponding matter profile with the obtained plurality of data items, where the matter profile includes a set of involved custodian identifiers which are representative of corresponding potential custodians. The system then compares data items associated with each involved custodian identifier and consolidates ones of the custodian identifiers that are determined to be associated with a single one of the potential custodians. For each of the potential custodians, the system compares data items associated with the potential custodian to determine a level of relevance of the potential custodian to a target matter. A subset of the potential custodians having higher relevance (e.g., the corresponding levels of relevance are above a selectable threshold) are then selected and output including the selected subset of the potential custodians is generated and provided as output to an output interface.

In another embodiment, an automated method for electronic discovery of documents and document custodians comprises receiving, by a server executing an electronic discovery system, an identifier of a first custodian and accessing data stores to obtain a set of data items associated with the first custodian. Obtained data items are stored in an original format as obtained from the corresponding data stores. The method further includes building, with the obtained data items, a custodian profile for the first custodian and accessing the data stores to identify matters associated with the first custodian. For each of the identified matters, a corresponding matter profile is built with the obtained data items, where the matter profile includes a set of involved custodian identifiers representative of corresponding potential custodians. Data items associated with each involved custodian identifier are compared and ones of the involved custodian identifiers that are determined to be associated with a single one of the potential custodians are consolidated. For each of the potential custodians, data items associated with the potential custodian are compared to determine a level of relevance of the potential custodian to a target matter, and a subset of the potential custodians having higher levels of relevance (e.g., levels above a selectable threshold) are selected. The selected subset of the potential custodians is then provided as an output to a user or to an eDiscovery system component.

In some embodiments, comparing data items associated with each involved custodian identifier comprises accessing human resources (HR) records corresponding to each involved custodian identifier, and consolidating ones of the involved custodian identifiers that are determined to be associated with the single one of the potential custodians comprises consolidating involved custodian identifiers that are identified by the HR records as corresponding to the single one of the potential custodians.

In some embodiments, the method further comprises assigning low levels of relevance to potential custodians who were not associated with a target enterprise at a time of a target event.

Another alternative embodiment comprises a method for recommending custodians in a litigation, where the method comprises receiving a set of custodian exemplars and a set of inputs related to litigation practice, generating a set of custodian candidates for the litigation based on the set of custodian exemplars and the set of inputs related to litigation practice, comparing the set of custodian candidates based on a set of comparison conditions, deriving one or more custodians for the litigation from the set of custodian candidates based on the comparing of the set of custodian candidates, and sending the one or more derived custodians for the litigation to a user as a recommendation.

The set of inputs related to litigation practice may comprise a history of litigation for an organization, and the litigation includes the organization as one of the parties. The set of custodian exemplars and the set of custodian candidates may be either current or former employees of the organization. The set of custodian exemplars may be derived from one or more custodians of a past litigation of the organization.

In some embodiments, a first portion of the set of inputs related to litigation practice are associated with the set of custodian exemplars and a second portion of the set of input related to litigation practice are associated with the set of custodian candidates, where the generating of the set of custodian candidates comprises comparing the first portion and the second portion based on a set of generating conditions, and selecting the set of custodian candidates based on the comparing.

The set of comparison conditions may comprise matching employment data for the set of custodian candidates, matching expertise data for the set of custodian candidates, and matching groups for the set of custodian candidates.

Sending the one or more derived custodians for the litigation to a user as a recommendation may comprise forwarding the recommendation to a predictive case strategy system for managing the litigation.

Another alternative embodiment comprises a method for managing litigation. This method includes receiving a subject litigation case for an organization, determining a set of litigation attributes for the subject litigation case, the set of litigation attributes including an issue for the subject litigation case, a set of keywords for the subject litigation case, and a set of custodians for the subject litigation case. He method further includes deriving a set of litigation case candidates representing litigation cases of the organization, determining a set of litigation attributes for each of the litigation case candidates, the set of litigation attributes including an issue for each of the litigation case candidates, a set of keywords for each of the litigation case candidates, and a set of custodians for each of the litigation case candidates. The set of litigation attributes for the subject litigation case are then compared with the set of litigation attributes for each of the litigation case candidates, and a litigation case representative is generated from the set of litigation case candidates based on the comparing.

In some embodiments determining the set of litigation attributes for the subject litigation case comprises processing file briefs for the subject litigation case, and determining the set of litigation attributes for each of the litigation case candidates comprises processing file briefs for each of the litigation case candidates.

In some embodiments, determining the set of litigation attributes for the subject litigation case further comprises processing meet and confer terms, processing productions, and processing a case summary, and determining a set of litigation attributes for each of the litigation case candidates further comprises processing meet and confer terms, processing productions, and processing a case summary.

In some embodiments, comparing the set of litigation attributes for the subject litigation case with the set of litigation attributes for each of the litigation case candidates comprises matching one or more of the issues, the set of keywords, and the set of custodians for the subject litigation case and each of the litigation case candidates, and generating the representative litigation case from the set of litigation case candidates is based on the matching.

In some embodiments, the method further comprises determining the set of custodians for the litigation case representative, and setting the set of custodians for the subject litigation case to the set of custodians for the litigation case representative.

In some embodiments, the set of custodians for the subject litigation case is received from a custodian recommendation system.

In some embodiments, the litigation case representative is a plurality of litigation case representatives, and the method further comprises ranking the plurality of litigation case representatives.

Embodiments of the technology may be implemented on a computing system. Any suitable combination of mobile desktop, server machine, embedded or other types of hardware may be used. One exemplary embodiment may be implemented in a distributed network computing environment. The computing environment in this embodiment may include a client computer system and a server computer system connected to a network (e.g., a local area network (LAN), a wide area network (WAN) such as the Internet, mobile network, or other type of network or combination thereof). The network may represent a combination of wired and wireless networks that network computing environment may utilize for various types of network communications.

The computer systems may include, for example, a computer processor and associated memory. The computer processor may be an integrated circuit for processing instructions, such as, but not limited to a CPU. For example, the processor may comprise one or more cores or micro-cores of a processor. The memory may include volatile memory, non-volatile memory, semi-volatile memory or a combination thereof. The memory, for example, may include RAM, ROM, flash memory, a hard disk drive, a solid-state drive, an optical storage medium (e.g., CD-ROM), or other computer readable memory or combination thereof. The memory may implement a storage hierarchy that includes cache memory, primary memory or secondary memory. In some embodiments, the memory may include storage space on a data storage array. The client computer system may also include input/output (“I/O”) devices, such as a keyboard, monitor, printer, electronic pointing device (e.g., mouse, trackball, stylus, etc.), or the like. The client computer system may also include a communication interface, such as a network interface card, to interface with the network.

The memory may store instructions executable by the processor. For example, the memory may include an operating system, a page editing or processing program (e.g., a web browser or other program capable of rendering pages), a server program configured to extend the functionality of the page processing program or other server code. Further, the memory may be configured with a page processable (e.g., capable of being rendered by) by the page editing program. The page may be the local representation of a page, such as a web page, retrieved from the network environment. As will be appreciated, while rendering the page, the page editing/processing program may request related resources, such as style sheets, image files, video files, audio files and other related resources as the page is being rendered and thus, code and other resources of the page may be added to the page as it is being rendered. Application server code can be executable to receive requests from client computers, generate server page files from a set of page assets (e.g., complete web pages, page fragments, scripts or other assets) and return page files in response. A page file may reference additional resources, such as style sheets, images, videos, audio, scripts or other resources at a server computer system or at other network locations, such as at additional server systems.

According to some embodiments, a network environment may be configured with a page such as a web page which is configured to launch and connect to an instance of the server program. The page may include a page file containing page code (HTML or other markup language, scripts or code), stored or generated by the server computer system, that references resources at the server computer system or other network locations, such as additional server computer systems. The page file or related resources may include scripts or other code executable to launch and connect to an instance of the server program.

Those skilled in the relevant art will appreciate that the embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any, hardware system, hardware mechanism or hardware component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein, including R, Python, C, C++, Java, JavaScript, HTML, or any other programming or scripting code, etc. Communications between computers implementing embodiments can be accomplished using any electronic, optical, radio frequency signals, or other suitable methods and tools of communication in compliance with known network protocols.

Any particular routine can execute on a single computer processing device or multiple computer processing devices, a single computer processor or multiple computer processors. Data may be stored in a single storage medium or distributed through multiple storage mediums.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. An automated system for electronic discovery of documents and document custodians, the system comprising:
an electronic discovery server machine;
a plurality of data sources coupled by a network to the electronic discovery server machine, each of the data sources storing data of a corresponding data management tool;
wherein the electronic discovery server machine is adapted to:
receive from an input interface an identifier of a first custodian;
obtain from the data sources a plurality of data items associated with the first custodian;
determine from the obtained plurality of data items one or more matters associated with the first custodian;
determine from the obtained plurality of data items identifiers of potential custodians associated with the identified matters;
compare, for each of the potential custodians, data items associated with the potential custodian to determine a corresponding level of relevance of the potential custodian to a target matter;
select a subset of the potential custodians having corresponding levels of relevance above a configurable threshold; and
generate output including the selected subset of the potential custodians and providing the output to an output interface.

2. The system of claim 1, wherein the plurality of data sources store multiple, disparate types of data for the corresponding data management tools in multiple, disparate data structures.

3. The system of claim 1, wherein the electronic discovery server machine is further adapted to store the obtained plurality of data items in an original format as obtained from the corresponding data management tools.

4. The system of claim 1, wherein the electronic discovery server machine is further adapted to build, with the obtained plurality of data items, a first custodian profile for the first custodian.

5. The system of claim 1, wherein the electronic discovery server machine is further adapted to compare data items associated with each potential custodian identifier and consolidate ones of the potential custodian identifiers that are determined to be associated with a single potential custodian.

6. The system of claim 1, wherein the electronic discovery server machine is further adapted to, for each of the identified matters, build, with the obtained plurality of data items, a corresponding matter profile, wherein the matter profile includes a corresponding set of custodian identifiers representative of corresponding potential custodians associated with the identified matter.

7. The system of claim 1, wherein the level of relevance of each potential custodian is determined by adding relevance contributions of a plurality of data items associated with the potential custodian.

8. The system of claim 7, wherein the relevance contribution of each data item is based at least in part on a data type associated with the data item and at least in part on an association of the data item with either the target matter or the one or more identified matters.

9. The system of claim 1, wherein the electronic discovery server machine is further adapted to assign low levels of relevance to potential custodians who were not associated with a target enterprise at a time of a target litigation event.

10. The system of claim 1, wherein the electronic discovery server machine is further adapted to receive from an input interface setting the configurable threshold.

11. A method for automated electronic discovery of documents and document custodians, the method comprising:
receiving, by an electronic discovery server machine, an identifier of a first custodian;
obtaining from the data sources a plurality of data items associated with the first custodian;
determining from the obtained plurality of data items one or more matters associated with the first custodian;
determining, by the electronic discovery server machine from the obtained plurality of data items, identifiers of potential custodians associated with the identified matters;
comparing, by the electronic discovery server machine, data items associated with the potential custodian to determine a corresponding level of relevance of the potential custodian to a target matter;
selecting, by the electronic discovery server machine, a subset of the potential custodians having corresponding levels of relevance above a configurable threshold; and
generating, by the electronic discovery server machine, output including the selected subset of the potential custodians and providing the output to an output interface.

12. The method of claim 11, wherein the plurality of data sources store multiple, disparate types of data for the corresponding data management tools in multiple, disparate data structures.

13. The method of claim 11, wherein the electronic discovery server machine is further adapted to store the obtained plurality of data items in an original format as obtained from the corresponding data management tools.

14. The method of claim 11, wherein the electronic discovery server machine is further adapted to build, with the obtained plurality of data items, a first custodian profile for the first custodian.

15. The method of claim 11, wherein the electronic discovery server machine is further adapted to compare data items associated with each potential custodian identifier and consolidate ones of the potential custodian identifiers that are determined to be associated with a single potential custodian.

16. The method of claim 11, wherein the electronic discovery server machine is further adapted to, for each of the identified matters, build, with the obtained plurality of data items, a corresponding matter profile, wherein the matter profile includes a corresponding set of custodian identifiers representative of corresponding potential custodians associated with the identified matter.

17. The method of claim 11, wherein the level of relevance of each potential custodian is determined by adding relevance contributions of a plurality of data items associated with the potential custodian.

18. The method of claim 17, wherein the relevance contribution of each data item is based at least in part on a data type associated with the data item and at least in part on an association of the data item with either the target matter or the one or more identified matters.

19. The method of claim 11, wherein the electronic discovery server machine is further adapted to assign low levels of relevance to potential custodians who were not associated with a target enterprise at a time of a target litigation event.

20. The method of claim 11, wherein the electronic discovery server machine is further adapted to receive from an input interface setting the configurable threshold.
